(19) United States
(12) Patent Application Publication
(10) Pub. No.: US 2005/0102609 A1
(43) Pub. Date: May 12, 2005

(54) Image processing apparatus, image processing method, and image processing program

(75) Inventors: Rieko Izume, Sakai-shi (JP); Noriyuki Okisu, Osakasayama-shi (JP); Motohiro Nakanishi, Kobe-shi (JP); Takehisa Yamaguchi, Ikoma-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 10/982,144

(22) Filed: Nov. 4, 2004

(30) Foreign Application Priority Data
Nov. 10, 2003 (JP) 2003-379845

(51) Int. Cl. G06F 17/21

(52) U.S. Cl. 715/512

(57) ABSTRACT

An image processing apparatus is provided that permits the clear grasping of the relationship between images and annotations when a plurality of images having annotations added to partial regions thereof are reproduced one after another. On a personal computer screen, when images taken with a digital camera are presented in a slide show, each parent image having annotations added thereto along with all the images added as annotation to that parent image is regarded as a group, and one such group after another is presented. Within each group, the parent image is reproduced before any of the images added as annotations thereto. When a parent image is reproduced, frames indicating the regions to which annotations are added are shown superimposed thereon.

This application is based on Japanese Patent Application No. 2003-379845 filed on Nov. 10, 2003, the contents of which are hereby incorporated by reference.

### BACKGROUND OF THE INVENTION

1. Field of the Invention

The present invention relates to an image processing apparatus, an image processing method, and an image processing program for performing image processing including the reproduction of images and of annotations added to partial regions thereof.

2. Description of Related Art

It is commonly practiced to display a plurality of still images one after another, with each image kept shown for a predetermined length of time. This helps grasp the relationship among different images easily, and also helps enhance the sense of presence. This has originally been practiced with images taken on silver-halide film (slides), and thus this way of presenting images is generally called a slide show.

Today, it is also commonly practiced to display images taken with a digital camera or images produced on a personal computer one after another on a personal computer. Displaying one digital image after another in this way also is called a slide show. In what order to present images in a slide show of digital images is discussed in Japanese Patent Applications Laid-Open Nos. 2001-103415 and 2002-300520.

On the other hand, it has been proposed to add annotations to partial regions of images taken with a digital camera. This helps enhance such images' capability to convey information. Annotations can be added to images on the digital camera itself that was used to take them, or on a personal computer after the images have been transferred thereto. In either case, the user can specify regions of desired sizes in desired positions on images and add thereto annotations in the form of images, sounds, character strings, etc. More than one annotation can be added to a single image.

In a slide show, even images having annotations added to partial regions thereof can be presented. However, to date, no proposals have been made as to, in such a slide show, in what order to present images having annotations added thereto and the annotations themselves.

Annotations can be added whenever the user wants them to be added. Accordingly, if images and annotations are reproduced in order of the dates and times at which the images were taken and at which the annotations were added, the reproduction of a given image and of the annotations added thereto is interspersed with the reproduction of images and annotations unrelated thereto. This makes it extremely difficult to grasp the relationship between images and annotations, and thus greatly spoils the sense in adding annotations to images and in performing a slide show.

### SUMMARY OF THE INVENTION

In view of the conventionally experienced inconveniences described above, it is an object of the present invention to provide an image processing apparatus, an image processing method, and an image processing program that permits the clear grasping of the relationship between images and annotations when images are reproduced one after another as in a slide show.

To achieve the above object, in one aspect of the present invention, an image processing apparatus for performing image processing including the reproduction of an image and of an annotation added to a partial region thereof is provided with: a reproduction portion for reproducing an image and an annotation added thereto; a detection portion for detecting the correspondence between an image and an annotation added thereto; a determination portion for determining, based on the correspondence detected by the detection portion, the order in which to make the reproduction portion reproduce a plurality of images and annotations; and a control portion for making the reproduction portion reproduce the plurality of images and annotations in the order determined by the determination portion.

In this image processing apparatus, the order in which to reproduce images and annotations is determined based on the correspondence between the images and annotations. Thus, when a plurality of images are presented one after another as in a slide show, the user can easily grasp which annotations are added to which images.

Here, whereas images are reproduced by being displayed, annotations are reproduced, depending on whether they are images, characters, or sounds, either displayed or outputted as sounds. The image processing apparatus may be so designed as to only perform the reproduction of images and annotations, or may be so designed as to perform other operations such as the taking of images, the adding of annotations to images, and the editing of images.

Here, advisably but not necessarily, the determination portion so operates that an image having an annotation added thereto is reproduced before the annotation added to the image is reproduced. With this configuration, the user can grasp an entire image before using annotations.

Advisably but not necessarily, the determination portion so operates that, when an annotation is an image that has an annotation added thereto, the image is reproduced before the annotation added thereto is reproduced. With this configuration, the user can grasp an entire image added as an annotation before using the annotations further added thereto.

Advisably but not necessarily, when there are a plurality of images having an annotation added thereto, the determination portion regards each image along with the annotation added thereto as a group and determines the order of reproduction in such a way that the reproduction is performed group by group. With this configuration, in a slide show, it is possible to reproduce an image followed by all the annotations added thereto before proceeding to the next image. This ensures the clear grasping of the relationship between images and annotations.

Advisably but not necessarily, the reproduction portion, when reproducing an image having an annotation added thereto, shows on the reproduced image the region to which the annotation is added. With this configuration, it is possible to recognize which annotation is added to which region on an image.

Advisably but not necessarily, the reproduction portion, when reproducing an image having an annotation added thereto, shows in different modes of display the region to which the annotation is added and the remaining region. For example, the different regions are displayed with different brightness or in different colors.

Advisably but not necessarily, the reproduction portion, after reproducing an image having an annotation added thereto and before reproducing the annotation, reproduces with enlargement the region to which the annotation is added. With this configuration, the user can grasp an entire image and the regions thereon to which annotations are added and then use the annotations.

To achieve the above object, in another aspect of the present invention, an image processing method for performing image processing including the reproduction of an image and of an annotation added to a partial region thereof includes the steps of: detecting the correspondence between an image and an annotation added thereto; determining, based on the detected correspondence, the order in which to reproduce a plurality of images and annotations; and reproducing the plurality of images and annotations in the determined order.

To achieve the above object, in still another aspect of the present invention, an image processing program containing instructions for making a computer perform image processing including the reproduction of an image and of an annotation added to a partial region thereof includes: an instruction to detect the correspondence between an image and an annotation added thereto; an instruction to determine, based on the detected correspondence, the order in which to reproduce a plurality of images and annotations; and an instruction to reproduce the plurality of images and annotations in the determined order.

To achieve the above object, in a further aspect of the present invention, an image processing apparatus is provided with: a storage portion for storing an image and an annotation associated with the image; a detection portion for detecting the correspondence between an image and an annotation associated with the image which are stored in the storage portion; a reproduction portion for reproducing an image and an annotation associated with the image which are stored in the storage portion; and a control portion for controlling, based on the correspondence detected by the detection portion, how to make the reproduction portion reproduce images and annotations.

Here, advisably but not necessarily, an annotation is associated with a partial region of an image; or the correspondence between an image and an annotation is recorded in a particular file; or the correspondence between an image and an annotation is recorded in a file in which the annotation is recorded; or the control portion controls the order in which to make the reproduction portion reproduce images and annotations.

### BRIEF DESCRIPTION OF THE DRAWINGS

FIGS. 1A and 1B are a perspective view and a rear view, respectively, schematically showing the exterior appearance of the digital camera of a first embodiment of the invention;

FIG. 1C is a diagram schematically showing the configuration of the above digital camera;

FIG. 2 is a flow chart showing the flow of operations performed to take an annotation image in the above digital camera;

FIGS. 3A to 3E are diagrams showing examples of the images displayed in the course of the taking of an annotation image on the above digital camera;

FIG. 4 is a diagram showing the folder structure of a file created in the course of the taking of an annotation image in the above digital camera;

FIG. 5 is a diagram showing an example of the contents of an association file created in the above digital camera;

FIGS. 6A to 6D are diagrams showing examples of the screen that is displayed initially when parent images having annotation images added thereto are presented on the above digital camera;

FIG. 7 is a diagram schematically showing the external appearance of the personal computer of a second embodiment of the invention;

FIG. 8 is a diagram schematically showing the configuration of the above personal computer;

FIGS. 9A to 9C are diagrams showing examples of the screens that are displayed when parent images having annotation images added thereto are presented on the above personal computer;

FIGS. 10A to 10F are diagrams showing examples of the images presented in a slide shown on the above digital camera or on the above personal computer;

FIGS. 11A to 11F are diagrams showing the order in which images are presented in a slide show according to a first reproduction method;

FIGS. 12A to 12H are diagrams showing the order in which images are presented in a slide show according to a second reproduction method;

FIGS. 13A and 13B are diagrams showing other examples of display according to the second reproduction method;

FIGS. 14A to 14L are diagrams showing the order in which images are presented in a slide show according to a third reproduction method; and

FIGS. 15A to 15I are diagrams showing the order in which images are presented according to the second reproduction method when annotation images have annotation images added thereto.

### DETAILED DESCRIPTION OF PREFERRED EMBODIMENTS

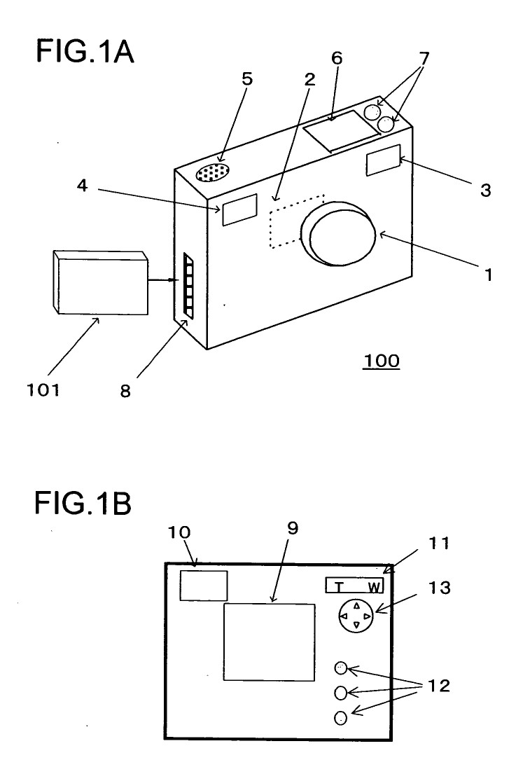

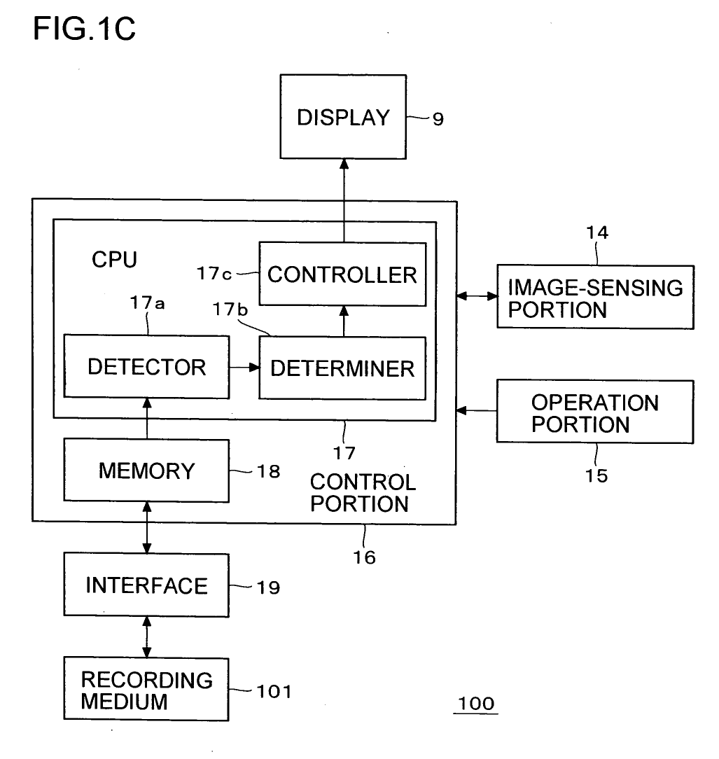

Hereinafter, embodiments of the present invention will be described with reference to the accompanying drawings. The digital camera of a first embodiment of the invention is shown in FIGS. 1A and 1B. FIGS. 1A and 1B are a perspective view and a rear view, respectively, of the digital camera 100.

The digital camera 100 is provided with: on the front face, a taking lens 1, a viewfinder front window 3, a flash emission portion 4; on the top face, a release button 5, a liquid crystal display 6, two shooting mode setting buttons 7; on a side face, a slot 8 into which a removable recording medium 101 is inserted; on the rear face, a liquid crystal display 9, a viewfinder rear window 10, a zoom button 11, three operation buttons 12, and a cross button 13. The digital camera 100 incorporates a CCD area sensor 2, and takes an image by focusing the light from a subject through the taking lens 1 on the CCD sensor 2. With each image thus taken, an annotation in the form of an image can be added thereto in a region specified thereon by the user.

In the following descriptions, an image taken as an annotation is called an annotation image, and an image to which an annotation has already been added or is about to be added is called a parent image. Annotation images are taken just in the same manner as other ordinary images are taken. All images including annotation images can be displayed on the liquid crystal display 9.

The release button 5, when pressed halfway in, produces an S1 signal that requests the execution of automatic exposure control and automatic focus adjustment, and, when pressed fully in, produces an S2 signal that requests the starting of the taking of an image to be recorded and the recording of the taken image to the removable recording medium 101. The liquid crystal display 6 displays the settings that are currently valid on the digital camera 100. The digital camera 100 has a normal shooting mode for shooting ordinary images including parent images and an annotation shooting mode for shooting annotation images. The shooting mode setting buttons 7 are operated to switch between these modes. The removable recording medium 101 is for storing taken images, and is realized with, for example, a memory card containing semiconductor memory housed in a slim casing.

The liquid crystal display 9 displays taken images and operation guides. The digital camera 100 has a shooting mode for taking images and a playback mode for displaying reproduced images. The shooting mode includes the normal and annotation shooting modes mentioned above. In the shooting mode, images are sensed repeatedly at substantially fixed time intervals, with each sensed image immediately displayed on the liquid crystal display 9. These images provide a live view, i.e., the image of the subject currently being sensed, that is used, along with the optical image observed through the viewfinder rear window 10, for framing and zooming purposes.

In the playback mode, the images recorded on the removable recording medium 101 are read out for display on the liquid crystal display 9. The images that can be displayed in the playback mode include, as well as ordinary images including parent images, annotation images.

The zoom button 11 is operated to set the focal length of the taking lens 1, which is built as a zoom lens. The operation buttons 12 are operated, when an operation guide is displayed on the liquid crystal display 9, to select and confirm particular items. The functions assigned to the three operation buttons 12 vary according to what operation guide is displayed at the moment. The functions assigned to the operation buttons 12 are classified roughly into those related to shooting conditions and those related to the addition of annotations. When the operation buttons 12 are assigned functions related to the addition of annotations, they function, for example, as a select button for selecting an image (parent image) to which to add an annotation, a size change button for changing the size of the region to which to add an annotation, and a set button for confirming the selected parent image or the changed size, to name a few.

The cross button 13 has a total of four contacts, namely two horizontally arranged and two vertically arranged, and is operated to move upward, downward, leftward, and rightward the cursor (pointer) displayed on the liquid crystal display 9. Operating this cross button 13 permits the position of the region to which to add an annotation to be changed. In the following description, the cross button 13 is also called the direction button.

The configuration of the digital camera 100 is schematically shown in FIG. 1C. The digital camera 100 is provided with, in addition to an image-sensing portion 14 including the taking lens 1 and the CCD area sensor 2 and an operation portion 15 including all the operation members including the operation buttons 12, a control portion 16 and an interface 19. The interface 19 handles the input and output to and from the removable recording medium 101.

The control portion 16 includes a CPU 17 and a memory 18. The CPU 17 controls the operation of the entire digital camera 100; specifically, it controls the taking of an image by the image-sensing portion 14, the displaying of an image by the liquid crystal display 9, and the recording of an image to the removable recording medium 101 by the interface 19. The CPU 17 also executes the addition of an annotation to an image.

When the CPU 17 is considered from the perspective of the functions thereof related to the reproduction of images and annotations, it includes a detector 17a for detecting the correspondence between the images and annotations recorded on the removable recording medium 101, a determiner 17b for determining, based on the correspondence detected by the detector 17a, the order in which to present the images and annotations, and a controller 17c for making the liquid crystal display 9 reproduce the images and annotations in the order determined by the determiner 17b.

In the memory 18 is stored the program according to which the CPU 17 performs its control. The memory 18 is also used to temporarily store various kinds of data including image data.

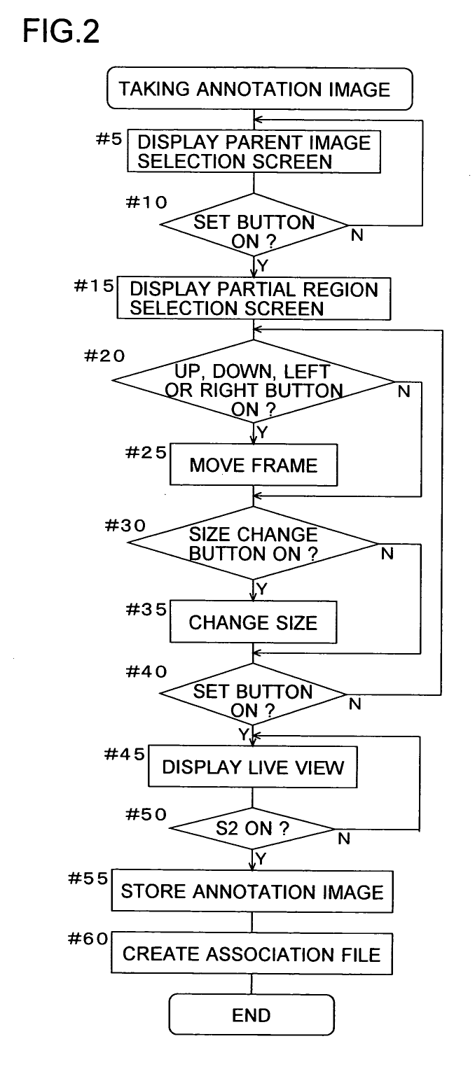

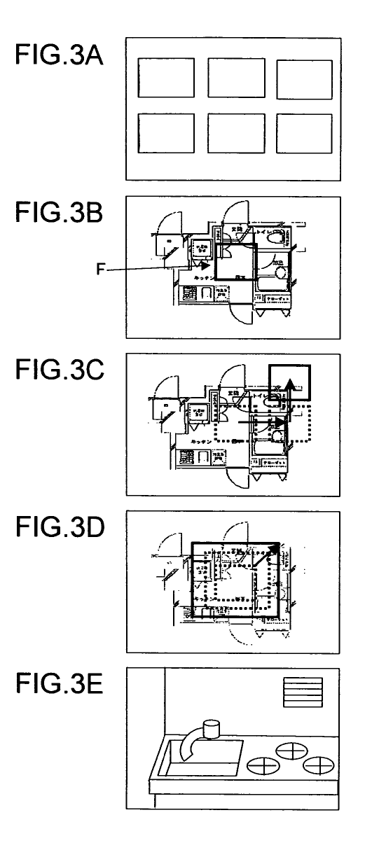

The flow of operations performed to take an annotation image is shown in FIG. 2, and examples of the images displayed on the liquid crystal display 9 during that flow of operations are shown in FIGS. 3A to 3E. Now, with reference to these figures, the flow of operations for taking an annotation image will be described.

When the annotation shooting mode is started, first, a guide screen for permitting the selection of a parent image is displayed on the liquid crystal display 9 (FIG. 2, step #5). This guide screen shows, as shown in FIG. 3A, the thumbnail images (reduced images) of the images recorded on the removable recording medium 101 in a neatly arranged fashion. Next, a wait lasts until, through the operation of the selection buttons, an image is selected and then, through the operation of the set button, the selected image is confirmed as a parent image (#1 0).

When the parent image is confirmed, a guide screen is displayed for permitting the specification of a region on the image to which to add an annotation (#15). This guide screen shows, as shown in FIG. 3B, the entire parent image along with a frame F indicating the region previously determined by as a default region to which to add an annotation. Then, whether or not, through the operation of the direction button, the movement of the region is requested is checked (#20), and, if so, as shown in FIG. 3C, the region (frame F) is moved as requested (#25).

Next, whether or not, through the operation of the size change button, the change of the size of the region is requested is checked (#30), and, if so, as shown in FIG. 3D, the size of the region (frame F) is changed (#35). The size of the region can be changed in several previously determined steps, and, every time the size change button is operated, the region is enlarged one step. When the size change button is operated with the region already in its maximum size (corresponding to the entire parent image), the size of the region is changed to its minimum.

Next, whether or not, through the operation of the set button, the position and size of the region to which to add an annotation is confirmed is checked (#40), and, if no such request is made, the flow returns to step #20. If such a request is made, as shown in FIG. 3E, a live view is displayed (#45). Incidentally, the sensing of the image to be displayed as the live view was already started at the moment that the shooting mode was started, and simply the display thereof has since been suspended during the operations in steps #5 to #40.

After the live view is displayed, a wait lasts until, through the operation of the release button 5, an S2 signal is produced (#50). When the release button 5 is operated, prior to an S2 signal, an S1 signal is produced. At the moment that the S1 signal is produced, automatic exposure control and automatic focus adjustment are executed.

When the S2 signal is produced, an image is taken, and this image is, as an annotation image, recorded to the removable recording medium 101 (#55). Then, a file that contains the correspondence between the parent image and the annotation image is created and is recorded to the removable recording medium 101 (#60).

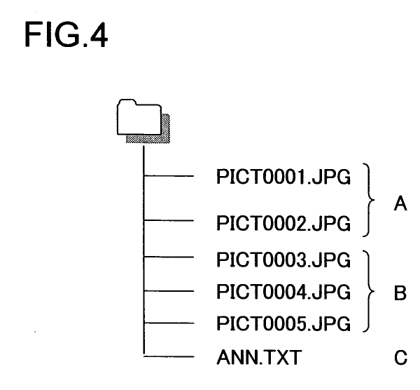

The folder structure of a file created during the taking of an annotation image is shown in FIG. 4. The file of a parent image and the file of an annotation image added to the parent image are created in the same folder, and these files are serially numbered in the order in which the images they contain were taken, irrespective of these images are parent or annotation images.

In FIG. 4, “A” indicates the files of parent images, which were either taken in the ordinary shooting mode or were previously recorded to the removable recording medium 101 by the user. “B” indicates the files of annotation images, and “C” indicates an association file. The contents of an association file are: the path name to the folder it is in; the file names of parent images; the shooting dates and times of the parent images; the positions and sizes of regions to which annotation images are added; and the file name of the annotation images added to those regions.

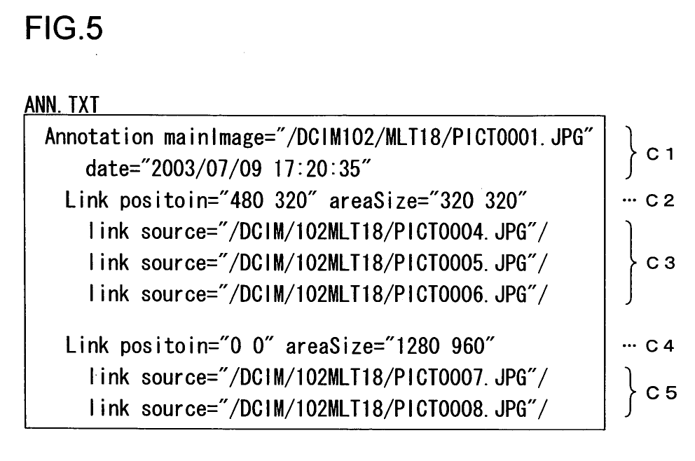

An example of the contents of an association file is shown in FIG. 5. In FIG. 5, “C1” indicates the path name, file name, and shooting date and time of a parent image. “C2” indicates the position and size of one region to which an annotation image is added, and “C3” indicates the path name and file name of the annotation image added to that region. “C4” indicates the position and size of another region to which an annotation image is added, and “C5” indicates the path name and file name of the annotation image added to that region.

The position and size of a region to which an annotation image is added are expressed in terms of the pixels it involves horizontally and vertically. The position of a region is expressed by the position of the uppermost, leftmost pixel of the annotation image relative to the origin, namely the upper left corner of the parent image. The information indicating the position and size of one region is followed by the file name of the annotation image added to that region. In the example shown in FIG. 5, two regions C2 and C4 are set in one parent image C1, with three annotation images C3 added to the region C2 and two annotation images C5 added to the region C4.

Instead of creating an association file that contains the correspondence between parent and annotation images, it is also possible to record information indicating such correspondence to the tags (headers) of the files of parent and annotation images. In that case, the information recorded to the tag of a given file contains: distinction of whether the file contains a parent or annotation image; for a parent image, the shooting date and time, the position and size of a region to which an annotation image is added, and the file name of the annotation image added to that region; and, for an annotation image, the file name of the parent image and the position and size of the region on the parent image to which the annotation image is added.

These items of information may be recorded only to the tags of the files of parent images, or only to the tags of the files of annotation images. Both in a case where the correspondence between parent and annotation images is recorded in an association file and in a case where it is recorded in the tags of files, the information recorded for that purpose may also contain the shooting dates and times of annotation images.

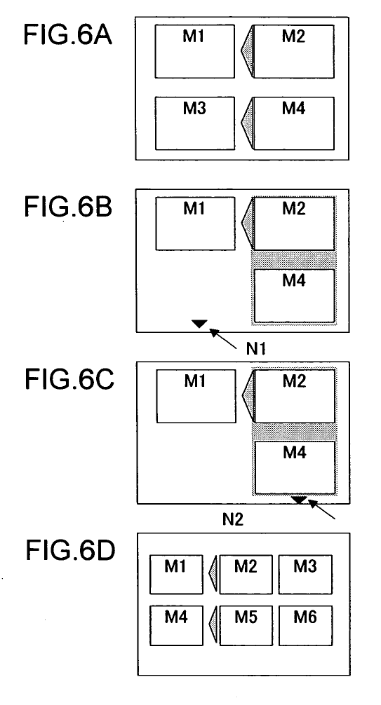

A few examples of the screen displayed initially when parent images having annotation images added thereto are presented on the digital camera 100 are shown in FIGS. 6A to 6D. When the playback mode is started, the thumbnail images of both parent and annotation images are shown in a neatly arranged fashion, along with symbolic images indicating which annotation images are added to which parent images.

FIG. 6A shows a case in which two parent images M1 and M3 and two annotation images M2 and M4 are displayed. The parent images are shown in the left-hand half of the screen, and the annotation images are shown in the right-hand half of the screen. Between the annotation image M2 and the parent image M1 is shown a leftward pointing triangular image, which indicates that the former is added to the latter. Likewise, between the annotation image M4 and the parent image M3 is shown a leftward pointing triangular image, which indicates that the former is added to the latter.

FIG. 6B shows a case in which one parent image M1 and two annotation images M2 and M4 are displayed. The two annotation images M2 and M4 are enclosed in a rectangular image, which in turn connects to a leftward pointing triangular image. These symbolic images indicate that the annotation images M2 and M4 are added to the parent image M1. Below the parent image M1 is shown a downward pointing triangular image N1, which indicates that there exist more parent images other than the parent image M1. When the parent image is selected through the operation of the direction button and then the down button (part of the direction button) is operated, the next parent image is displayed along with the annotation images added thereto.

FIG. 6C shows a case in which, as in the case just described, one parent image M1 and two annotation images M2 and M4 are displayed. The difference from FIG. 6B is that, instead of the triangular image N1, a different triangular image N2 is shown. This image N2 is shown below the annotation images M2 and M4, and indicates that there exist, other than the annotation images M2 and M4, more annotation images added to the parent image M1. When the annotation image M4 is selected through the operation of the direction button and then the down button is operated, the next annotation image added to the parent image M1 is displayed.

FIG. 6D shows a case in which two parent images M1 and M4 and four annotation images M2, M3, M5, and M6 are displayed. The annotation images M2 and M3 are shown in the same row as the parent image M1, and the annotation images M5 and M6 are shown in the same row as the parent image M4. Between the annotation image M2 and the parent image M1 is shown a leftward pointing triangular image, which indicates that the annotation images M2 and M3 are added to the parent image M1. Likewise, between the annotation image M5 and the parent image M4 is shown a leftward pointing triangular image, which indicates that the annotation images M5 and M6 are added to the parent image M4.

Displaying parent and annotation images in this way makes it possible to present them in a way that permits the clear grasping of the correspondence between parent and annotation images. Needless to say, more thumbnails images may be displayed at a time than are displayed in the examples specifically described above.

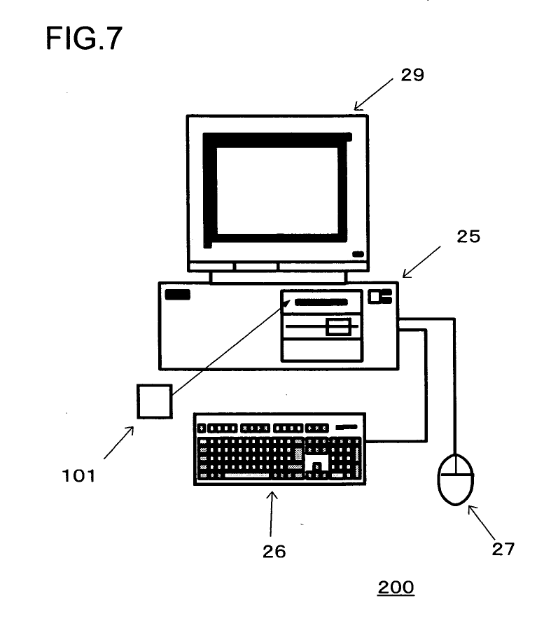

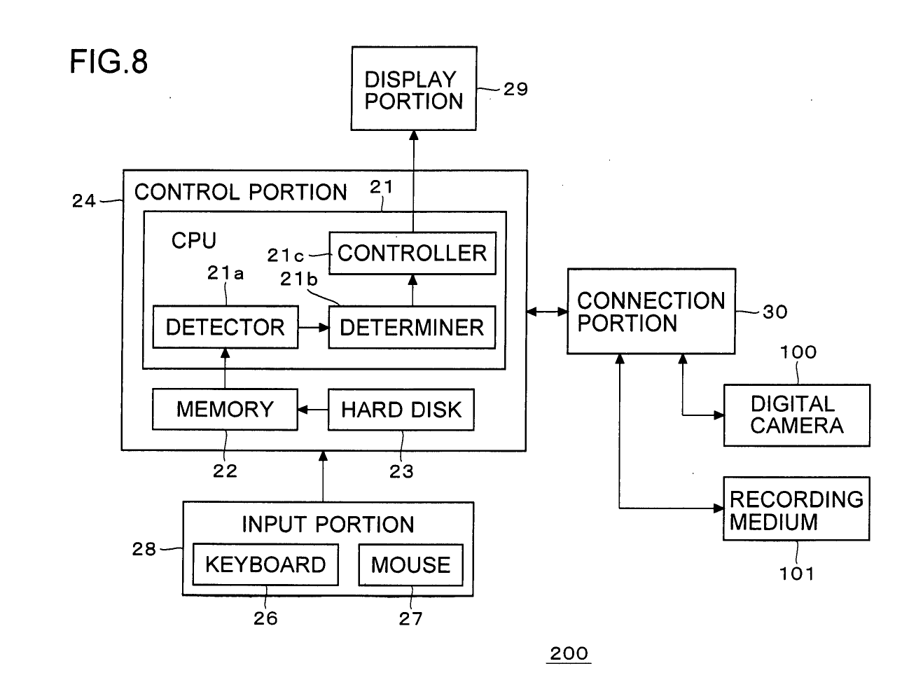

The exterior appearance of the personal computer 200 of a second embodiment of the invention is shown in FIG. 7, and the configuration thereof is schematically shown in FIG. 8. The personal computer 200 is provided with: a main unit 25 incorporating a control portion 24 including a CPU 21, a memory 22, a hard disk 23, and other components; an input portion 28 including a keyboard 26, a mouse 27, and the like; and a display portion 29. The main unit 25 is also provided with a connection portion 30 that permits the removable recording medium 101 described earlier and another recording medium such as an optical disk to be mounted thereon and that permits the digital camera 100 or the Internet to be connected thereto.

The personal computer 200 cannot take images, but can, like the digital camera 100, add annotations to partial regions on images and reproduce images and annotations. Images and annotations are reproduced by being displayed on the display portion 29. These and all the other operations that the personal computer 200 performs are recorded on the hard disk 23.

Images to which to add annotations are fed from an external apparatus, for example in the form of images taken with the digital cameral 100, through the connection portion 30 to the personal computer 200. The personal computer 200 can read the images recorded on the removable recording medium 101, and can acquire images by way of an unillustrated cable. Images can even be acquired by being downloaded from a website on the Internet or by being received in the form of files appended to electronic mail.

When the CPU 21 of the control portion 24 is considered from the perspective of the functions thereof related to the reproduction of images and annotations, it includes a detector 21a for detecting the correspondence between the images and annotations recorded on the hard disk 23, a determiner 21b for determining, based on the correspondence detected by the detector 21a, the order in which to present the images and annotations, and a controller 21c for making the display portion 29 reproduce the images and annotations in the order determined by the determiner 21b.

On the personal computer 200, not only annotation images but also character strings can be added as annotations to images. In the following descriptions, a character string added as an annotation to an image is called an annotation character string. Annotation character strings are entered from the keyboard 26. The selection of a parent image to which to add an annotation and the specification of the position and size of the region to which to add the annotation are performed, with an operation guide displayed on the display portion 29, in the same manner as in the first embodiment. The necessary operations are performed with the keyboard 26 or the mouse 27. The selection of an annotation image is performed in the same manner as that of a parent image.

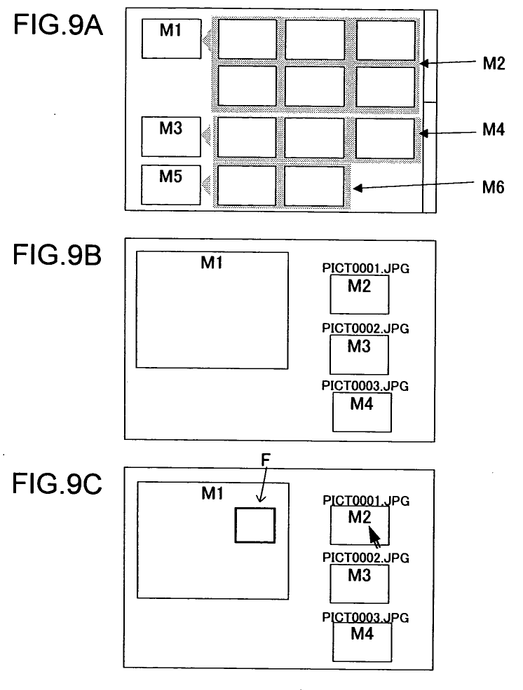

Examples of the screens displayed when parent images having annotation images added thereto are presented on the personal computer 200 are shown in FIGS. 9A to 9C. First, as shown in FIG. 9A, the thumbnail images of parent and annotation images are displayed in a neatly arranged fashion, along with symbolic images as described earlier that indicate which annotation images are added to which parent images. Here, for annotation character strings, which cannot be appropriately represented with thumbnail images, predetermined symbolic figures are displayed instead.

In this example, three parent images M1, M3, and M5 and 11 annotation images are displayed. Of these annotation images, six images M2 are added to the parent image M1, three images M4 are added to the parent image M3, and two images M6 are added to the parent image M5.

Any of the displayed thumbnail images can be selected through the operation of the mouse 27 or the keyboard 26. The same is true with any symbolic figure representing an annotation character string.

When the thumbnail image of a parent image is selected, the image is displayed in its original format without reduction, along with the thumbnail images and file names of the annotation images added to that parent image. FIG. 9B shows an example of such a screen. Here, any of the displayed file names can also be selected.

In this state, when the thumbnail image or file name of any of the annotation images is selected, a frame F that indicates the region to which that annotation image is added is shown superimposed on the parent image currently being displayed. FIG. 9C shows an example of such a screen. Showing the frame F superimposed on the parent image in this way helps clearly grasp the portion of the parent image to which the annotation image is added.

Both the digital camera 100 of the first embodiment and the personal computer 200 of this embodiment are capable of performing a slide show in which a plurality of images are presented one after another, with each image kept shown for a predetermined length of time. In a slide show, not only images but also the annotation images and annotation character strings added to the images can be presented. In a slide show, they can be presented by one of three methods, of which any can be freely selected by the user. According to any of the methods, each parent image along with all the annotations added thereto is regarded as one group, and one such group after another is presented; moreover, within each group, first the parent image is presented and then the annotations added thereto are presented.

On the personal computer 200, the order of presentation is determined by the CPU 21, serving as the determiner 21b, of the control portion 24 according to the program stored on the hard disk 23. Here, the CPU 21 finds the correspondence between parent images and annotations by referring to the association file stored in the hard disk 23. In a case where the correspondence between parent images and annotations are recorded in the tags of files, these tags are referred to instead. As described earlier, the digital camera 100 of the first embodiment, too, is provided with the control portion 16 including the CPU 17 and the memory 18 in which the program therefor is stored (see FIG. 1C). Thus, like the CPU 21 in this embodiment, there the CPU 17, serving as the determiner 17b, determines the order in which to present images in a slide show.

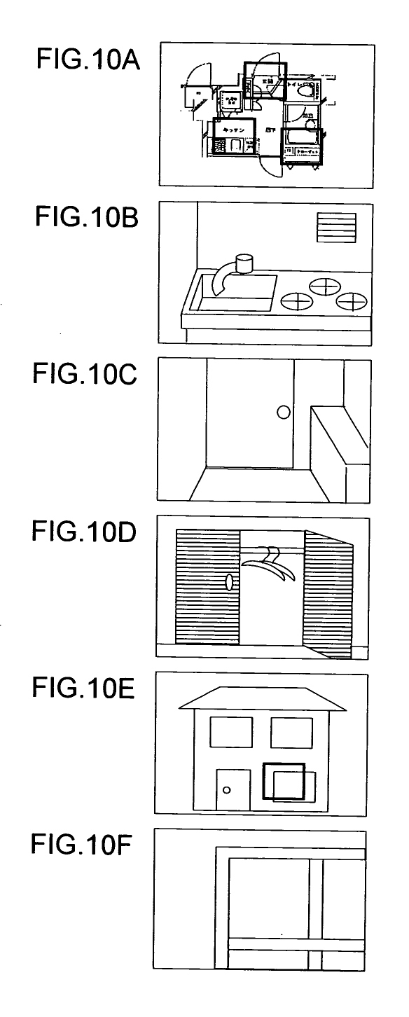

Now, the three methods of presentation will be described one by one, considering as an example a case in which six images as shown in FIGS. 10A to 10F are presented in a slide show. FIGS. 10A and 10E show parent images, FIGS. 10B, 10C, and 10D show annotation images added to the parent image shown in FIG. 10A, and FIG. 10F shows an annotation image added to the parent image shown in FIG. 10E.

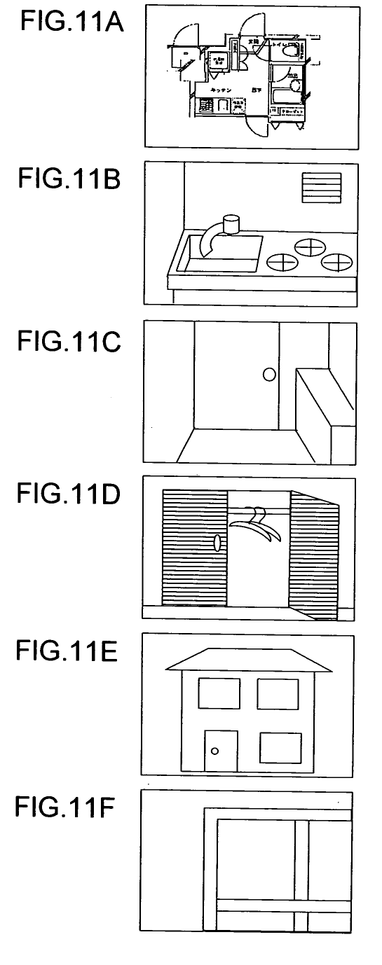

According to the first method of presentation, first, one parent image is reproduced, then all the annotation images added to this parent images are reproduced one after another, then another parent image is reproduced, and then the annotation images added to this parent images are reproduced one after another. The images reproduced by this method are shown in FIGS. 11A to 11F in the order in which they are presented.

The starting of a slide show is requested, on the personal computer 200, through the operation of the keyboard 26 or the mouse 27 and, on the digital camera 100, through the operation of the operation buttons 12. Different parent images are reproduced in the order in which they were taken (according to the serial numbers included in their file names), and, for a given parent image, the annotation images added thereto are also reproduced in the order in which they were taken. The parent image that is reproduced first may be specified by the user, with other parent images reproduced in order of shooting. Though not shown in FIGS. 11A to 11F, when a parent image is reproduced, frames that indicate the regions to which annotation images are added may be shown superimposed thereon.

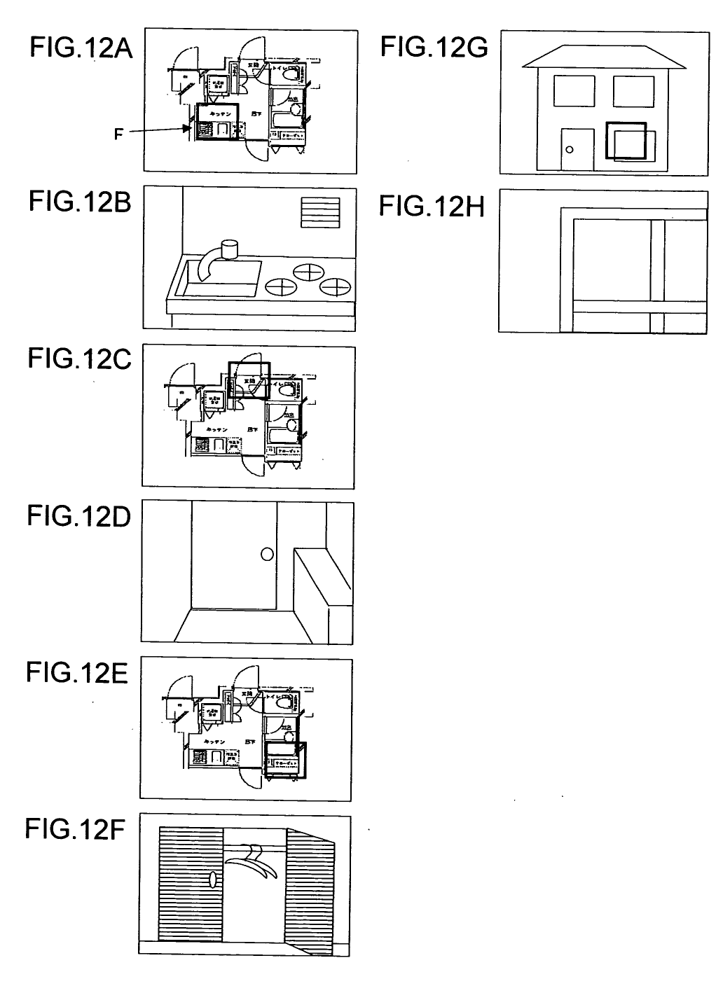

According to the second method of presentation, immediately before each annotation image is reproduced, the parent image to which this annotation image is added is displayed with a frame F that indicates the region to which that annotation image is added shown superimposed on the parent image. The images reproduced by this method are shown in FIGS. 12A to 12H in the order in which they are presented.

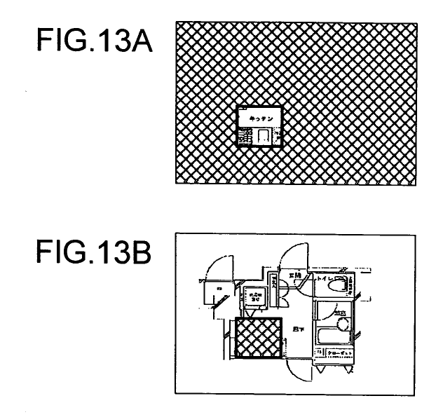

Instead of showing a frame F that indicates the region to which an annotation image is added, the region on a parent image to which an annotation image is added may be shown in a different mode of display from elsewhere. Such examples are shown in FIGS. 13A and 13B. FIG. 13A shows a case in which the region to which an annotation image is added is shown brighter than elsewhere, and FIG. 13B shows a case in which the region to which an annotation image is added is shown in a different color from elsewhere.

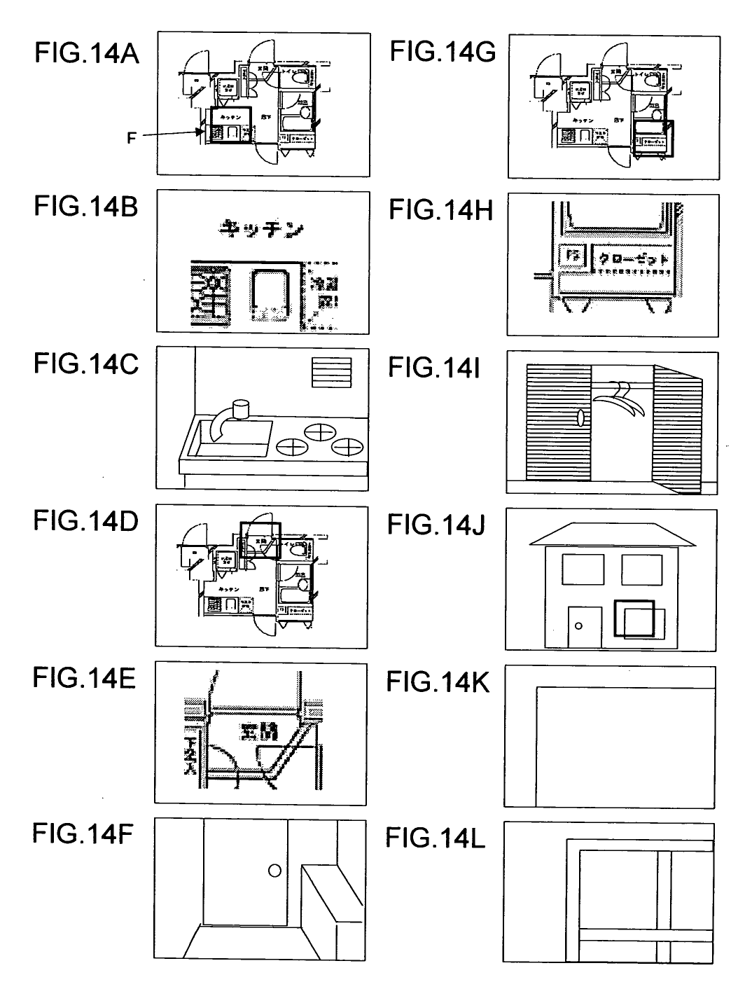

According to the third method of presentation, like the second method, immediately before each annotation image is reproduced, the parent image to which this annotation image is added is displayed. In addition to this, according to the third method, after a given parent image is reproduced and before an annotation image added thereto is reproduced, the region on the parent image to which this annotation image is added is reproduced with enlargement. The images reproduced by this method are shown in FIGS. 14A to 14L in the order in which they are presented.

FIGS. 14B, 14E, 14H, and 14K show the parent image reproduced with enlargement. In this example, frames F that indicate the regions to which annotation images are added are shown superimposed on the parent image. These frames F may be omitted.

In the course of a slide show, whether the image currently being displayed is a parent or annotation image may be indicated by displaying parent and annotation images with different symbolic figures such as icons added thereto or by displaying them enclosed in differently colored frames.

It is possible to further add annotations to partial regions on annotation images. Even images like these which have annotations added thereto in two or more hierarchical structure layers can be presented in a slide show performed according to one of the first to third methods of presentation described above. In such cases, the order in which to reproduce annotation images and the annotation images added thereto is determined just as is the order in which to reproduce parent images and the annotation images added thereto.

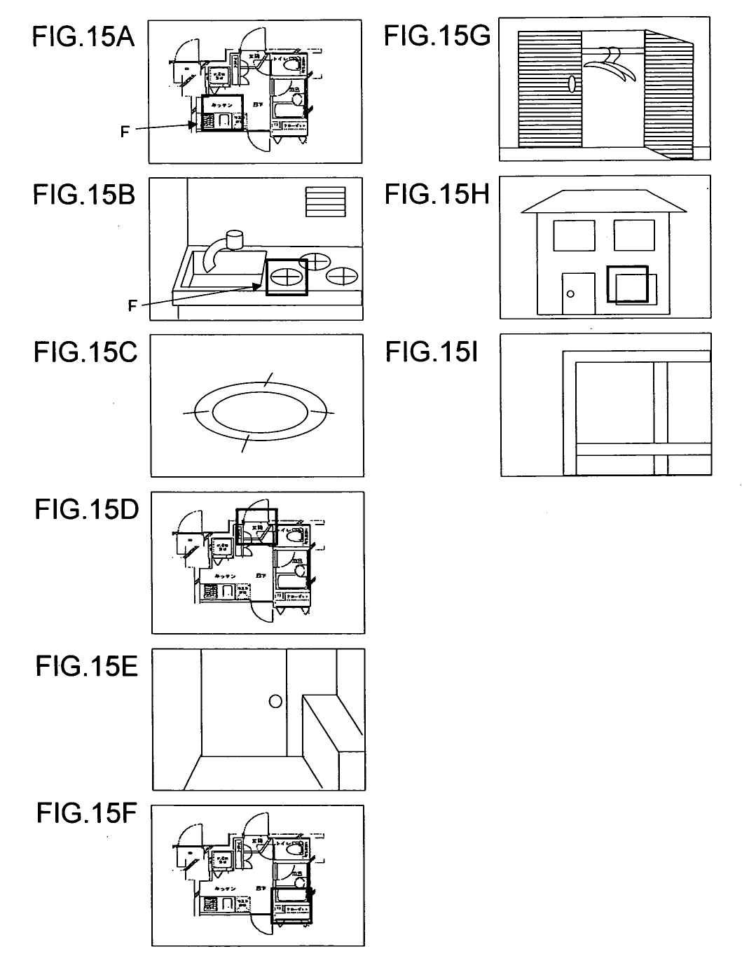

Considering as an example a case in which the annotation image shown in FIG. 10B has an annotation image added thereto, an example of how images are reproduced according to the second method of presentation is shown in FIGS. 15A to 15I. FIG. 15C is the annotation image added to the annotation image shown in FIG. 10B. The images are reproduced in the order shown in FIGS. 15A to 15I.

In a slide show, each image is kept displayed for a predetermined length of time. This length of time may be fixed, or may be selected by the user. Moreover, while an image is being displayed, an instruction from the user may be accepted to end the presentation of that image and proceed to the presentation of the next image.

The above descriptions deal with cases where all the annotations are images. It is, however, also possible to apply the first to third methods of presentation described above in cases where annotations include character strings. In such cases, character string annotations are reproduced by displaying the character strings. The digital camera 100 or the personal computer 200 may be additionally provided with a microphone and a loudspeaker so that sounds can be added as annotations to images and that the sounds added as annotations can be reproduced. In such cases, too, it is possible to apply the first to third methods of presentation described above.

Obviously, many modifications and variations of the present invention are possible in light of the above teachings. It is therefore to be understood that within the scope of the appended claims, the invention may be practiced other than as specifically described.

1. An image processing apparatus for performing image processing including reproduction of an image and of an annotation added to a partial region thereof, the image processing apparatus comprising:
a reproduction portion for reproducing an image and an annotation added thereto;
a detection portion for detecting correspondence between an image and an annotation added thereto;
a determination portion for determining, based on the correspondence detected by the detection portion, order in which to make the reproduction portion reproduce a plurality of images and annotations; and
a control portion for making the reproduction portion reproduce the plurality of images and annotations in the order determined by the determination portion.

2. An image processing apparatus as claimed in claim 1,
wherein the determination portion so operates that an image having an annotation added thereto is reproduced before the annotation added to the image is reproduced.

3. An image processing apparatus as claimed in claim 2,
wherein the determination portion so operates that, when an annotation is an image that has an annotation added thereto, the image is reproduced before the annotation added thereto is reproduced.

4. An image processing apparatus as claimed in claim 1,
wherein, when there are a plurality of images having an annotation added thereto, the determination portion regards each image along with the annotation added thereto as a group and determines the order of reproduction in such a way that the reproduction is performed group by group.

5. An image processing apparatus as claimed in claim 1,
wherein the reproduction portion, when reproducing an image having an annotation added thereto, shows on the reproduced image a region to which the annotation is added.

6. An image processing apparatus as claimed in claim 5,
wherein the reproduction portion, when reproducing an image having an annotation added thereto, shows in different modes of display a region to which the annotation is added and a remaining region.

7. An image processing apparatus as claimed in claim 2,
wherein the reproduction portion, after reproducing an image having an annotation added thereto and before reproducing the annotation, reproduces with enlargement a region to which the annotation is added.

8. An image processing method for performing image processing including reproduction of an image and of an annotation added to a partial region thereof, the image processing method comprising the steps of:
detecting correspondence between an image and an annotation added thereto;
determining, based on the detected correspondence, order in which to reproduce a plurality of images and annotations; and
reproducing the plurality of images and annotations in the determined order.

9. An image processing program containing instructions for making a computer perform image processing including reproduction of an image and of an annotation added to a partial region thereof, the instructions including:
an instruction to detect correspondence between an image and an annotation added thereto;
an instruction to determine, based on the detected correspondence, order in which to reproduce a plurality of images and annotations; and
an instruction to reproduce the plurality of images and annotations in the determined order.

10. An image processing apparatus comprising:
a storage portion for storing an image and an annotation associated with the image;
a detection portion for detecting correspondence between an image and an annotation associated with the image which are stored in the storage portion;
a reproduction portion for reproducing an image and an annotation associated with the image which are stored in the storage portion; and
a control portion for controlling, based on the correspondence detected by the detection portion, how to make the reproduction portion reproduce images and annotations.

11. An image processing apparatus as claimed in claim 10,
wherein an annotation is associated with a partial region of an image.

12. An image processing apparatus as claimed in claim 10,
wherein correspondence between an image and an annotation is recorded in a particular file.

13. An image processing apparatus as claimed in claim 10,
wherein correspondence between an image and an annotation is recorded in a file in which the annotation is recorded.

14. An image processing apparatus as claimed in claim 10,
wherein the control portion controls order in which to make the reproduction portion reproduce images and annotations.

15. An image processing apparatus as claimed in claim 14,
wherein the control portion so operates that an image having an annotation associated therewith is reproduced before the annotation associated with the image is reproduced.

16. An image processing apparatus as claimed in claim 15,
wherein, when a plurality of images having an annotation associated therewith are stored in the storage portion, the control portion regards each image along with the annotation associated therewith as a group and determines the order of reproduction in such a way that the reproduction is performed group by group.

17. An image processing apparatus as claimed in claim 11,
wherein the reproduction portion, when reproducing an image having an annotation associated therewith, shows on the reproduced image a region with which the annotation is associated.

18. An image processing apparatus as claimed in claim 17,
wherein the reproduction portion, when reproducing an image having an annotation associated therewith, shows in different modes of display a region with which the annotation is associated and a remaining region.

19. An image processing apparatus as claimed in claim 14,
wherein an annotation is associated with a partial region of an image,
wherein the control portion so operates that an image having an annotation associated therewith is reproduced before the annotation associated with the image is reproduced, and
wherein the reproduction portion, after reproducing an image having an annotation associated therewith and before reproducing the annotation associated with the image, reproduces with enlargement a region with which the annotation is associated.
